(19) United States
(12) Patent Application Publication
(10) Pub. No.: US 2002/0023378 A1
(43) Pub. Date: Feb. 28, 2002

(54) Placard strip

(76) Inventor: Michael Simon, Furth (DE)

Correspondence Address: BROWDY AND NEIMARK, P.L.L.C., 624 NINTH STREET, NW, SUITE 300, WASHINGTON, DC, 20001-5303, US

(21) Appl. No.: 09/916,225

(22) Filed: Jul. 27, 2001

(30) Foreign Application Priority Data
Jul. 27, 2000 (DE) 200 12 962.7

(51) Int. Cl. B32B 1/08; F16L 1/00; B65D 1/00; B29D 22/00

(52) U.S. Cl. 40/611; 428/36.9

(57) ABSTRACT

So as to embody a placard strip in which the assembly of the placard is improved, provision is made for a substantially annular cylindrical main body with a longitudinal slit for the accommodation of the placard that is to be joined to the placard strip; a first marginal area which is formed in a single piece with the main body and disposed contiguous to the slit; and a second marginal area which is formed in a single piece with the main body and disposed contiguous to the slit and opposite the first marginal area. The first marginal area has two clamping walls which are formed in a single piece with each other and rest planely on each other, receiving and clamping a margin of the placard.

### BACKGROUND OF THE INVENTION

1. Field of the Invention

The invention relates to a placard strip to be fixed to a placard, comprising a substantially annular cylindrical main body with a longitudinal slit for the accommodation of the placard that is to be connected with the placard strip; a first marginal area which is formed in a single piece with the main body and disposed contiguous to the slit; and a second marginal area which is formed in a single piece with the main body and disposed contiguous to the slit and opposite the first marginal area.

2. Background Art

Placards and in particular posters are provided in the vicinity of their upper edge with a placard strip to hang them up, freely suspended, or to attach them to a wall. Placard strips of the generic type have an annular cylindrical profile with a longitudinal slit. In the vicinity of the slit, two wall sections rest planely on each other; the placard is clamped between them and held in place. A drawback of this arrangement resides in that the placard can be pulled out of the slit without any problem. Frequently it is not possible to position the placard accurately in relation to the placard strip and to ensure alignment of the placard and the wall. The placard may even fall down completely.

### SUMMARY OF THE INVENTION

It is an object of the invention to embody a placard strip in which the assembly of the placard is improved.

This object is attained by the features which consist in that the first marginal area has two clamping walls which are formed in a single piece with each other and rest planely on each other, receiving and clamping a margin of the placard.

Additional advantages and details of the invention will become apparent from the description of an exemplary embodiment, taken in conjunction with the drawing.

### BRIEF DESCRIPTION OF THE DRAWING

FIG. 1 is an illustration of a placard with a placard strip; and FIG. 2 is a cross-sectional view on the line II-II in FIG. 1.

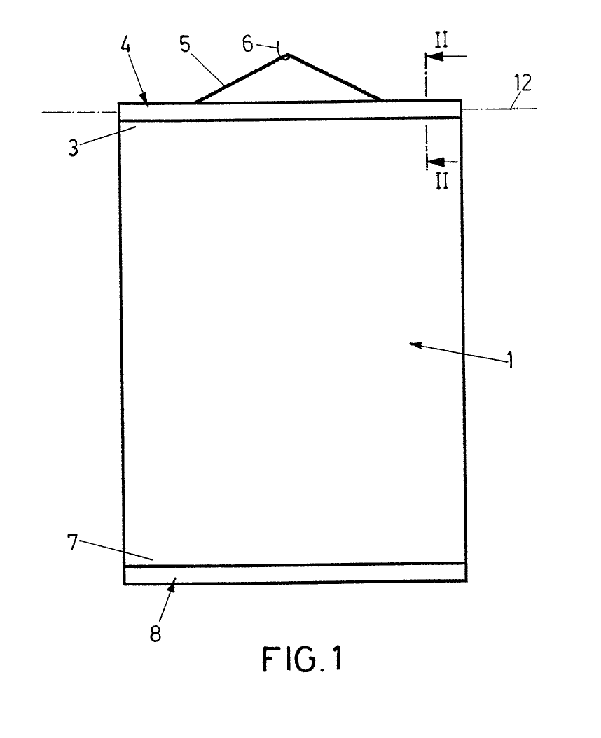

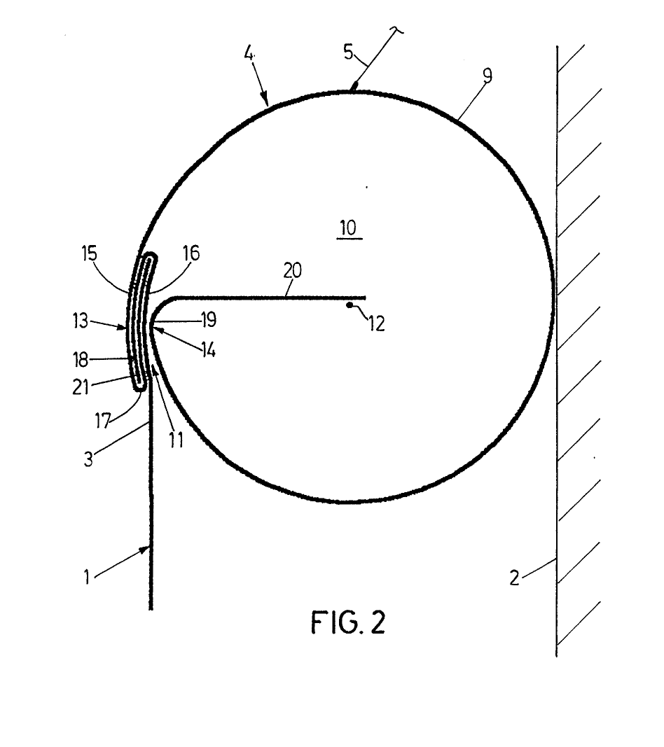

### DESCRIPTION OF THE PREFERRED EMBODIMENT

In order for a placard 1 to be freely suspended or fixed to a wall 2, the placard 1, which may be made of paper, fabric or any other suitable material, has a placard strip 4 on its upper edge 3; this placard strip 4 is also designated as a concave clamping strip. The placard strip 4, which is connected with the placard 1, possesses a suspension string 5, which is connected with the placard strip 4 at two points and hung over a hook 6 that is fixed to the wall 2. In the vicinity of the lower edge 7 of the placard 1, provision is made for a finishing strip 8, which is connected with the placard 1, weighting it down and ensuring the placard 1 to hang smoothly on the wall 2. Essentially, the finishing strip 8 has the same structure as the placard strip 4, however without a suspension string. It is of decisive importance for a smooth suspension behavior of the placard 1, in particular of a placard made of paper and PVC, ensuring smooth and straight suspension.

The following is a detailed description of the placard strip 4, taken in conjunction with FIG. 2. The placard strip 4 has a substantially annular cylindrical main body 9. The main body 9 may as well have a non-circular, in particular oval, cross-sectional shape. The main body 9 envelops an interior 10. The main body 9 has a longitudinal slit 11 that runs over the full length of the main body 9. The main body 9 has a marginal area 13 that forms a single piece therewith and defines the slit 11 radially outwards relative to the central longitudinal axis 12. Radially inwards, the slit 11 is formed by a marginal area 14 that lies opposite the marginal area 13 and forms a single piece with the main body 9. The marginal area 13 has a wall section 15 which forms a single piece with the main body 9 and is directly contiguous thereto, as well as a wall section 16 which is connected with the wall section 15 via a bending edge 17, planely resting radially inwards on the wall section 15. The wall sections 15 and 16 define a clamping gap 18 that is open toward the interior 10. The marginal area 14 has a rounded clamping edge 19 which is formed in a single piece with the main body 9 and is resiliently preloaded in the direction toward the wall section 16. Adjoining the clamping edge 19 is a wall section 20 that projects in the direction toward the central longitudinal axis 12.

For the placard 1 to be connected with the placard strip 4, the upper edge 3 of the placard 1 is led from below upwards through the slit 11 and the margin 21 is led from above downwards into the clamping gap 18 where it is clamped. The clamping edge 19 bears against the placard 1, clamping it in the slit 11 and in the clamping gap 18. As seen in FIG. 2, the placard 1 is led vertically downwards out of the slit 11 and thus freely suspended downwards. Clamping the placard 1 twice, namely in the slit 11 and in the clamping gap 18, and deflecting the margin 21 by 180° provides for excellent fit so that the placard 1 cannot slip or be pulled out of the placard strip 4. The fact that the placard 1 is fixed in the clamping gap 18 also ensures that the placard 1, which may also be made of fabric, is suspended planely and smoothly over its full width.

What is claimed is

1. A placard strip to be fixed to a placard (1), comprising
a substantially annular cylindrical main body (9) with a longitudinal slit (11) for the accommodation of the placard (1) that is to be connected with the placard strip;
a first marginal area (13) which is formed in a single piece with the main body (9) and disposed contiguous to the slit (11); and
a second marginal area (14) which is formed in a single piece with the main body (9) and disposed contiguous to the slit (11) and opposite the first marginal area (13);
wherein the first marginal area (13) has two clamping walls (15, 16) which are formed in a single piece with each other and rest planely on each other, receiving and clamping a margin (21) of the placard (1).

2. A placard strip according to claim 1, wherein a clamping gap (18) is formed between the two clamping walls (15, 16).

3. A placard strip according to claim 2, wherein the two clamping walls (15, 16) are connected with each other on the outward edge of the first marginal area (13).

4. A placard strip according to claim 2, wherein the clamping gap (18) is open towards the interior of the main body (9) for the accommodation of a margin (21) of the placard (1).

5. A placard strip according to claim 1, wherein the second marginal area (14) has a clamping edge (19) which is formed in a single piece with the main body (9), clamping the placard (1) that passes through the slit (11).

6. A placard strip according to claim 5, wherein the clamping edge (19) additionally clamps the margin (21) that is disposed in the clamping gap (18).

7. A placard strip according to claim 5, wherein the second marginal area (14) has a wall section (20) that extends from the clamping edge (19) to the center of the main body (9).

8. A placard strip according to claim 5, wherein the clamping edge (19) has a rounded cross-sectional shape.

9. A placard strip according to claim 2, wherein the slit (11) and the clamping gap (18) are contiguous to each other.

10. A placard strip according to claim 1, wherein the placard (1) is fixable in the slit (11) and in the clamping gap (18), forming a loop.
